(19) United States
(12) Patent Application Publication
(10) Pub. No.: US 2003/0041042 A1
(43) Pub. Date: Feb. 27, 2003

(54) Method and apparatus for knowledge-driven data mining used for predictions

(75) Inventors: Inon Cohen, Tel-Aviv (IL); Jehuda Hartman, Rehovot (IL); Yossi Fisher, Jerusalem (IL)

Correspondence Address: Dr. Robert Vasl,, InSyst Ltd., 7 Hamarpeh St, Har Hotzvim, Jerusalem, 91231, IL

(73) Assignee: InSyst Ltd, Jerusalem (IL)

(21) Appl. No.: 10/226,693

(22) Filed: Aug. 21, 2002

Related U.S. Application Data
(60) Provisional application No. 60/313,823, filed on Aug. 22, 2001.
(60) Provisional application No. 60/331,547, filed on Nov. 19, 2001.

(51) Int. Cl. G06N 5/00; G06F 17/00

(52) U.S. Cl. 706/45

(57) ABSTRACT

A method and apparatus is provided for constructing a predictive model for a system based on a priori qualitative modeling of the system and on historical database collected from past activity of the system or past events in the system. An expert provides grouping of parameters and qualitative dependencies between parameters and attributes, wherein some of the attributes may be conceptual or virtual attributes. The present invention extends existing methods of ‘evolutionary algorithms’ in order to build successive sets of quantitative predictive models for the system, wherein parts of each model are evolved by the evolutionary algorithm and parts of each model are derived using the historical database. According to the present invention a model constructed by this method can be incorporated as a predictive model into a diagnosis or control apparatus without the need for human inspection, as the model complies with the expert's knowledge about the system. The present invention also provides a method to update the constructed model when new data is delivered, thus adjusting the model to changes in the environment.

### RELATIONSHIP TO EXISTING APPLICATIONS

The present application claims priority from US Provisional Patent Application No. 60/313,823 and from US Provisional Patent Application No. 60/331,547. The disclosures of the following related applications are hereby incorporated by reference U.S. Ser. No. 09/731,978 filed Dec. 8, 2000.

### FIELD AND BACKGROUND OF THE INVENTION

The present invention relates to diagnostic and control systems and, more particularly, to a method for creating a model for predicting the output(s) of these systems.

In typical control systems, the primary goal is to achieve a particular output value by controlling (e.g., adjusting) input parameters. In order to accomplish this, predictive models are used, relating values of measured parameters (controllable and uncontrollable) to output values. A similar need for predictive models exist in diagnosis systems, which need to predict some state variable of the system (e.g. the quality of performance of a machine or the life expectancy of a person), based on measured parameters (input parameters).

When there is no known predictive model for a particular system, it is useful to construct a predictive quantitative model out of data collected from past activity of the system or past events in the system.

The predictive quantitative model (sometimes referred to as an empirical model) is established by using a procedure called data mining.

Data mining describes a collection of techniques that aim to find useful but undiscovered patterns in collected data. The main goal of data mining is to create models for decision making that predict future behavior based on analysis of past activity.

Data mining extracts information from an existing database to reveal “hidden” patterns of relationship between objects in that database, which are neither known beforehand nor intuitively expected.

The term “data mining” expresses the idea that the raw material is the “mountain” of data and the data mining algorithm is the excavator, shifting through the vast quantities of raw data looking for the valuable nuggets of information.

However, unless the output of the data mining system can be understood qualitatively, it won't be of any use. I.e. a user needs to overview the output of the data mining in a meaningful context to his goals, and to be able to disregard irrelevant patterns of the relationships that were disclosed.

It is in this overview stage in which human reasoning, hereinafter referred to as “expert input”, is needed to assess the validity and evaluate the plausibility and relevancy of the correlations found in the automated data mining and it is that indispensable expert input that prevents an accomplishment of a completely automated decision making system.

Several attempts have been made to eliminate this aforesaid need for the expert input, mainly by automatic organization or a priori restricting the vast repertoire of relationship patterns which are expected to be dug out by the data mining algorithm.

U.S. Pat. No. 5,225,366 to Kornacker describes the partition of database of case records into a tree of conceptually meaningful clusters wherein no prior domain-dependent knowledge is required.

U.S. Pat. No. 5,787,325 to Bigus describes an object oriented data mining framework mechanism, which allows the separation of the specific processing sequence and requirement of a specific data mining operation from the common attribute of all data mining operations.

U.S. Pat. No. 5,875,285 to Chang describes an object-oriented expert system, which is an integration of an object oriented data mining system with an object-oriented decision-making system and U.S. Pat. No. 6,073,138 to de l'Etraz, et al. discloses a computer program for providing relational patterns between entities.

Recently, dimension reduction was applied in order to reduce the vast quantity of relations identified by data mining.

Dimension reduction selects relevant attributes in the dataset prior to performing data mining. This is important for the accuracy of further analysis as well as for performance. Because the redundant and irrelevant attributes could mislead the analysis, including all of the attributes in the data mining procedures not only increases the complexity of the analysis, but also degrades the accuracy of the result.

Dimension reduction improves the performance of data mining techniques by reducing dimensions so that data mining procedures process data with a reduced number of attributes. With dimension reduction, improvement by orders of magnitude is possible.

The conventional dimension reduction techniques are not easily applied to data mining applications directly (i.e., in a manner that enables automatic reduction) because they often require a priori domain knowledge and/or arcane analysis methodologies that are not well understood by end users. Typically, it is necessary to incur the expense of a domain expert with knowledge of the data in a database. The expert determines which attributes are important for data mining. Some statistical analysis techniques, such as correlation tests, have been applied for dimension reduction. However, these are ad hoc and assume a priori knowledge of the dataset, which cannot be assumed to always be available. Moreover, conventional dimension reduction techniques are not designed for processing the large datasets that data mining processes.

In order to overcome these drawback in conventional dimension reduction, U.S. Pat. Nos. 6,032,146 and 6,134,555 both to Chadra, et al. disclose an automatic dimension reduction technique applied to data mining in order to determine important and relevant attributes for data mining without the need for the expert input of a domain expert.

Being completely automatic, such a dimension reduced data mining procedure is a “black box” for most end users who rely implicitly and “blindly” on its findings.

It is our opinion that defining relevancy between objects and events is still a human act, which cannot be replaced by a computer at the present time. Further more, most end users of an automatic decision making system would like to be involved in this decision making process at the conceptual level. I.e. they would like to visualize the “state of affairs” between factors that affect the final decision. They would even like to contribute to the algorithm of data mining by suggesting influential attributes and “cause and effect” relationships according to their own understanding.

Thus, we consider the expert(s) input to route and navigate the data mining according to a human knowledge and perception schemes as beneficial, provided it enables the processing of large datasets.

U.S. patent application Ser. No. 09/731,978 to Goldman et al filed Dec. 8, 2000 discloses a method for data mining of large datasets which includes an a-priori qualitative modeling of the system in hand, where the qualitative modeling is in the form of hierarchical grouping of the parameters and attributes of the system. The resulting predictive model is in the form of a hierarchy of intermediate functions converging information towards the output(s) of the system at hand. This method can be applied to produce a quantitative model when the outputs of all the intermediate functions are present in the collected data, in which case data-mining tools can be applied to produce each intermediate function independent of the other intermediate functions.

Often the expert is unable to divide the parameters based on collected (measured) attributes. The expert is almost always able (by his designation as an expert) to divide the parameters based on conceptual (virtual) variables and categories which are not present in the collected database, either because they were not measured, they are not measurable, or not even well defined. Such cases especially (but not exclusively) arise in systems that are not completely understood, as is often the case in medical systems, biological systems, and other systems which are not men-made.

There is therefore a need in the art for an improved method and tool in data mining of large datasets which includes an a priori qualitative modeling of the system at hand and which will enable the automatic use of the quantitative relations disclosed by a dimension reduced data mining, a method that can handle qualitative modeling of both actual and virtual parameters of the system devoid of the above-mentioned drawbacks. This need is especially pressing in systems related to medicine and biology.

### SUMMARY OF THE INVENTION

According to the present invention there is provided a method for constructing a predictive model for a system based on a priori qualitative modeling of the system and on data collected from past activity of the system or past events in the system. Using the dimension-reduction provided by the expert (grouping of parameters and qualitative dependencies between parameters and attributes), the present invention extends existing methods of ‘evolutionary algorithms’ in order to build quantitative functions for each of the dependencies (intermediate functions), functions that may include complex interactions between a multitude of parameters. The models constructed by the present invention can accommodate both actual and virtual (conceptual) parameters. According to the present invention a model constructed by this method can be incorporated as a predictive model into a diagnosis or control apparatus without the need for human inspection, as the model complies with the expert's knowledge about the system. According to the present invention there is also provided a method to update the constructed model when new data is delivered, thus adjusting the model to changes in the environment.

According to one aspect of the present invention there is provided a method for constructing a model for predicting values of at least one output parameter of a system from input parameters and attributes of the system, the method comprising a. defining dependencies between the input parameters, the attributes and at least one output parameter of the system, wherein at least a portion of the dependencies are not quantitatively known and at least a portion of the attributes are unmeasured; b. building a plurality of initial predictive models for the system, the initial predictive models having quantitative functions representing the dependencies, wherein at least one of the quantitative functions is derived using an historical database of the system (‘learning database’); c. building additional predictive models, similar to the initial models, with increasing accuracy in a process of an iterative evolutionary algorithm, where the additional predictive models having quantitative functions representing the dependencies. Some of the additional predictive models are marked during the iterative evolutionary algorithm; and d. selecting the most reliable of the marked models based on prediction of values of output parameters in a historical database.

According to yet another aspect of the present invention there is provided an apparatus for constructing a model for predicting values of at least one output parameter of a system from input parameters and attributes of the system, the apparatus comprising: a. a knowledge engineering tool for defining dependencies between the input parameters, the attributes and the at least one output parameter of the system, wherein at least a portion of the dependencies are not quantitatively known and at least a portion of the attributes are unmeasured; b. a first model generator for building a plurality of initial predictive models for the system, the initial predictive models having quantitative functions representing the dependencies, wherein at least one of the quantitative functions is derived using a learning database; c. a second model generator for building additional predictive models with increasing accuracy in a process of an iterative evolutionary algorithm, the additional predictive models having quantitative functions representing the dependencies, and the model generator marking some of the additional predictive models; and d. a selector for selecting the most reliable of the marked models based on prediction of values of output parameters in a historical database.

According to still another aspect of the present invention there is provided an apparatus for predicting values of at least one output of a system, said apparatus comprises: a. a modeler unit for constructing a model for predicting values of the least one output parameter of a system from input parameters and attributes of the system, the apparatus comprising: (i) a knowledge engineering tool for defining dependencies between the input parameters, the attributes and the at least one output parameter of the system, wherein at least a portion of the dependencies are not quantitatively known and at least a portion of the attributes are unmeasured; (ii) a first model generator for building a plurality of initial predictive models for the system, the initial predictive models having quantitative functions representing the dependencies, wherein at least one of the quantitative functions is derived using a first historical database of the system; and (iii) a second model generator for building additional predictive models with increasing accuracy in a process of an iterative evolutionary algorithm, the additional predictive models having quantitative functions representing the dependencies, and the second model generator marking some of the additional predictive models; and (iv) a selector for selecting the most reliable of the marked models based on prediction of values of output parameters in a historical database, the selected model is assigned to be a working model; and b. a diagnosis unit for predicting the at least one output value of the system.

According to yet another aspect of the present invention there is provided an apparatus for controlling values of at least one output of a system, said apparatus comprises: a. a modeler unit for constructing a model for predicting values of the least one output parameter of a system from input parameters and attributes of the system, the apparatus comprising: (i) a knowledge engineering tool for defining dependencies between the input parameters, the attributes and the at least one output parameter of the system, wherein at least a portion of the dependencies are not quantitatively known and at least a portion of the attributes are unmeasured; (ii) a first model generator for building a plurality of initial predictive models for the system, the initial predictive models having quantitative functions representing the dependencies, wherein at least one of the quantitative functions is derived using a first historical database of the system; and (iii) a second model generator for building additional predictive models with increasing accuracy in a process of an iterative evolutionary algorithm, the additional predictive models having quantitative functions representing the dependencies, and the second model generator marking some of the additional predictive models; and (iv) a selector for selecting the most reliable of the marked models based on prediction of values of output parameters in a historical database, the selected model is assigned to be a working model; and b. a control unit for manipulating parameters of the system and controlling the at least one output value of the system.

According to features in the described preferred embodiments the step of defining dependencies further comprises the steps of assigning the at least one output parameter and at least a portion of the input parameters and attributes of the system to be relevant parameters of the system, grouping the relevant parameters into groups of at least two, wherein any one of the relevant parameters is a member of at least one of the groups, and associating a qualitative dependency to each one of the groups wherein a single relevant parameter of the group is assigned to be a dependent parameter, and all of remaining relevant parameters of the group are assigned to be independent parameters.

According to further features in the described preferred embodiments the step of building a plurality of initial predictive models further comprises the steps of building an initial predictive model at least twice.

According to further features in the described preferred embodiments the step of building an initial predictive model further comprises the steps of representing by quantitative functions those of the dependencies whose functions are known beforehand, representing by randomly built quantitative functions those of the dependencies whose dependent parameter is unmeasured, and representing by quantitative functions derived using the learning database those of the dependencies whose dependent parameter is measured.

According to yet further features in the described preferred embodiments the step of representing by randomly built quantitative functions further comprises the steps of for those of the dependencies whose functional form is known beforehand, selecting random values of free parameters of the functional forms, and for those of the dependencies whose functional form is unknown, building random expressions which refer to independent parameters of the dependencies and follow a recursive syntax.

According to yet further features in the described preferred embodiments the step of representing by quantitative functions derived using the learning database those of the dependencies whose dependent parameter is measured further comprises the steps of calculating values of independent parameters of the dependencies for all records in the learning database, wherein some of the independent parameters are measured and the reminder of the independent parameters are dependent parameters of quantitative functions, and deriving a quantitative function by relating the independent parameters and the dependent parameter using a known statistical method to relate dependent parameter to at least one independent parameters.

According to yet further features in the described preferred embodiments the step of building additional predictive models further comprises the steps of assigning the initial predictive models to be current set of models, and iterating an evolutionary procedure until a stopping criteria is met.

According to yet further features in the described preferred embodiments the step of iterating an evolutionary procedure further comprises the steps of: a. calculating a fitness score for each model in the current set of models, the fitness score is based on the model's predictions of values of the at least one output parameter in the learning database, wherein a higher fitness score indicates better predictive accuracy and reliability; b. marking some, if any of the models in the current set of models, wherein preferably a model is marked only if it has a fitness score higher than the fitness score of all previously marked models and preferably a model is marked only if it has the highest fitness score in the current set of models; c. checking the stopping criteria and continuing only if the stopping criteria is not met, wherein the stopping criteria is based on the fitness score of the models in the current set of models and on the number of iterations iterated by the evolutionary procedure; d. selecting from the current set of models a set of founders for a new set of models, wherein the selecting is a probabilistic process based on the fitness score of models in the current set of models; e. building from the set of founders a new set of models, wherein each model in the new set is a result of either duplicating a model from the founders set, mutating a model from the founders set, or recombining at least two models from the founders set; f. re-deriving the quantitative functions of the dependencies whose dependent parameter is measured (the bound dependencies), the re-deriving is done by using the learning database; and g. assigning the new set of models to be current set of models.

According to yet further features in the described preferred embodiments the step of mutating a model from the founders set further comprises the step of performing minor change in at least one of those of the functions which are functions of unbound and not fixed dependencies, wherein the minor changes does not change functional form of a those of the functions whose functional form is known beforehand.

According to yet further features in the described preferred embodiments the step of recombining at least two models from the founders set further comprises the steps of selecting one of the at least two models to be a recipient model and the remaining models to be donor models, and recombining at least one of the functions which are functions of unbound and not fixed dependencies in the recipient model with functions of the same dependencies in the donor model, wherein recombining further comprises the step of replacing parts of the functions of the recipient model with parts of the functions of the donor models.

According to yet further features in the described preferred embodiments the step of re-deriving the quantitative functions of the bound dependencies further comprises the steps of calculating values of independent parameters of the dependencies for all records in the learning database, wherein some of the independent parameters are measured and the reminder of the independent parameters are dependent parameters of known quantitative functions, and deriving a quantitative function by relating the independent parameters and the dependent parameter using a known statistical method to relate dependent parameter to at least one independent parameters.

According to yet further features in the described preferred embodiments the step of selecting the most reliable of the marked models is done by either selecting from the marked models the model with the highest fitness score, or is done based on predictive accuracy on a historical database of the system different from the learning database (‘test database’).

According to still further features in the described preferred embodiments the apparatus of diagnosis unit further includes a data collector for collecting values of at least a portion of the input parameters, a predictor for predicting value of the at least one output parameter of the system, the prediction unit uses for prediction the working model, and an output device for reporting the predicted value of the at least one output of the system.

According to still further features in the described preferred embodiments the apparatus of diagnosis unit further includes a first data collector for collecting values of at least a portion of the input parameters, a predictor for predicting value of the at least one output parameter of the system, the prediction unit uses for prediction the working model, an output device for reporting the predicted value of the at least one output of the system, a second data collector for collecting actual output values of the at least one output parameter, a data storage unit for storing the collected data and the collected actual output values and maintaining a updated historical database, and a model maintainer for re-deriving, based on the updated historical database, the functions of the bound dependencies in the working model based on the updated historical database.

According to still further features in the described preferred embodiments the apparatus of control unit further includes a data collector for collecting values of a portion of the input parameters, wherein a portion of remaining the input parameters are assigned to be controllable parameters, a goal input device for indicating to the control unit desired values of the at least one output parameter, an optimizer for finding the values of the controllable parameters for which predicted values of the at least one output parameter of the system are similar to the desired values of the at least one output parameter, the optimizer using the working model for predicting values of the at least one output parameter of the system, and an output device for reporting or setting the found values of the controllable parameters.

According to still further features in the described preferred embodiments the apparatus of control unit further includes a first data collector for collecting values of a portion of the input parameters, wherein a portion of remaining the input parameters are assigned to be controllable parameters, a goal input device for indicating to the control unit desired values of the at least one output parameter, an optimizer for finding the values of the controllable parameters for which predicted values of the at least one output parameter of the system are similar to the desired values of the at least one output parameter, the optimizer using the working model for predicting values of the at least one output parameter of the system, an output device for reporting or setting the found values of the controllable parameters, a second data collector for collecting actual output values of the at least one output parameter, a data storage unit for storing the collected data and the collected actual output values and maintaining a updated historical database, and a model maintainer for rederiving, based on the updated historical database, the functions of the bound dependencies in the working model based on the updated historical database.

The present invention successfully addresses the shortcomings of the presently known configurations by providing a framework where the expert can describe qualitative relations between parameters without being constrained by the details of the collected data, and the present invention “mines” the data for an accurate quantitative model. The method of the present invention is more efficient then standard evolutionary algorithms (such as ‘Genetic Algorithms’ and ‘Genetic Programming’) because it utilizes the dimension reduction provided by the expert.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flowchart of an algorithm of an embodiment for constructing a predictive model.

FIG. 2 is a schematic description of a particular embodiment of a Knowledge Tree (KT), representing relationships between the input parameters and the output parameter, as provided by the expert;

FIG. 3 is a portion of a screen shot of an embodiment of the present invention, presenting a portion of a Knowledge Tree and a specific prediction of a model created by the embodiment

FIG. 4 is schematic description of an embodiment of a Knowledge Tree (KT) of a special nature, wherein all the input parameters are the independent parameters of a single dependency.

FIG. 5 is a function in a Knowledge Tree, similar to functions that are used when the dependent parameter is unknown and the functional form is known.

FIG. 6 is a tree-like representation of a function in a Knowledge Tree, similar to functions that are used when the dependent parameter is unknown and the functional form of the function is unknown; and

FIG. 7 is a flowchart of an evolutionary algorithm that builds a multitude of models and selects the best one.

### DESCRIPTION OF THE PREFERRED EMBODIMENTS

The present invention is of a data-mining method that can be used to construct a predictive model that is in compliance with an expert's knowledge about the system at hand.

Specifically, the present invention can be used to construct a predictive model when there is a large corpus of data collected from past activity of the system or past events in the system (a historical database), the data comprised of a multitude of parameters. The present invention utilizes expert's description of qualitative dependencies between parameters, and it is especially useful when some or all of these dependencies rely on unmeasured or immeasurable attributes.

The principles and operation of a method and an apparatus for constructing predictive models according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

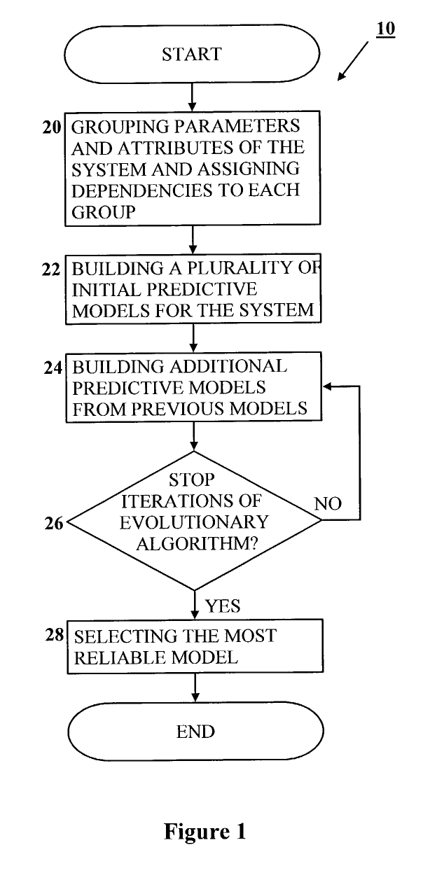

Referring now to the drawings, FIG. 1 illustrates a flowchart of a preferred embodiment of a method 10 for constructing a model for predicting values of at least one output parameter of a system from input parameters and attributes of the system. Method 10 includes defining dependencies between the input parameters, the attributes and at least one output parameter of the system 20, wherein at least a portion of the dependencies are not quantitatively known and at least a portion of the attributes are unmeasured. Method 10 also includes the step of building a plurality of initial predictive models for the system 22, the initial predictive models having quantitative functions representing the dependencies, wherein at least one of the quantitative functions is derived using an historical database of the system (‘learning database’). Method 10 also includes the step of building additional predictive models 24, similar to the initial models, with increasing accuracy in a process of an iterative evolutionary algorithm 24,26, where the additional predictive models having quantitative functions representing the dependencies. Some of the additional predictive models are marked during the iterative evolutionary algorithm. Method 10 also includes the step of selecting the most reliable of the marked models based on prediction of values of output parameters in a historical database (either the learning database or a different one, ‘test database’).

It is to be emphasized that the input parameters, the attributes and the at least one output parameter can be of various types and structures, such as a categorical type, an ordinal type, a numeric type, a vectoric type etc. Particularly, a parameter or an attribute that it is a vector of values is equivalent to values of multiple parameters or attributes. Accordingly, it is to be understood that the term “output parameter” may refer to more than one output of the system.

According to a preferred embodiment, the step of defining dependencies further includes the step of assigning the output parameter and at least some of the input parameters and attributes of the system to be relevant parameters of the system. In a typical medical system, such as clinical trials wherein the output may be for example survival rate following a certain procedure, information concerning hundreds of parameters is collected about each patient. Preferably, an expert decides which of the separameters are relevant for prediction of the output. The step of defining dependencies 20 further includes grouping the relevant parameters into groups of at least two, wherein any one of the relevant parameters is a member of at least one of the groups (a parameter which is not a member of any of the groups is rendered iaselevant parameter by the expert). Preferably, each group contains limited number of relevant parameter, as the present invention utilize the dimension-reduction implied by the grouping of relevant parameters. The step of defining dependencies 20 further includes associating a qualitative dependency to each one of the groups wherein a single relevant parameter of the group is assigned to be a dependent parameter, and all of remaining relevant parameters of the group are assigned to be independent parameters. A dependent parameter of one dependency may be an independent parameter of another group or groups.

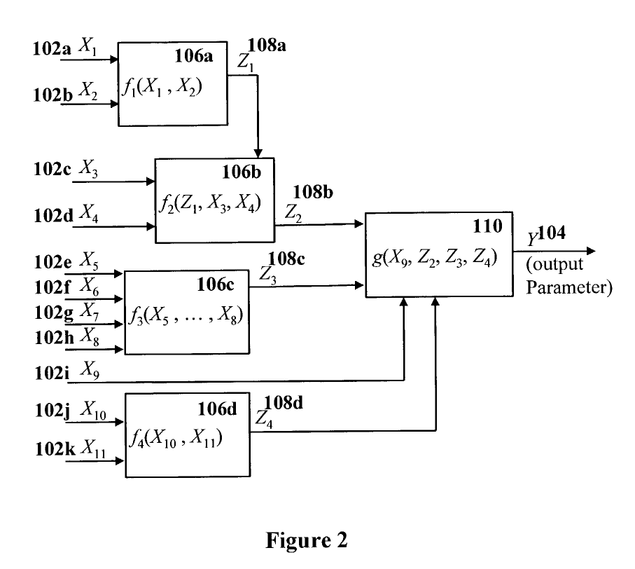

Reference is made to FIG. 2 which illustrates a schematic representation of qualitative dependencies between various input parameters, attributes, and an output parameter of a system. Such schematic representations are built by an expert to the system as described in U.S. patent application Ser. No. 09/731,978 to Goldman et al filed Dec. 8, 2000, which is incorporated by reference for all purposes as if fully set forth herein. Such a schematic representation is known as a Knowledge Tree map. It describes hierarchical converging of information from the input parameters 102a . . . 102k (x₁, x₂, . . . , x₁₁ in FIG. 2) through a series of intermediate attributes 108a . . . 108d (z₁, Z₂, Z₃ and z₄), to the output parameter 104. The parameters and attributes are related by dependencies (106a . . . 106d, 110), with each one of them having one dependent parameter and at least one independent parameter. Any intermediate parameter is a dependent parameter of a dependency and an independent parameter of another dependency. The intermediate parameters may be measured (present in the learning database) or unmeasured (not present in the learning database). The dependency whose dependent parameter is the output of the system is assigned to be a concluding dependency. Dependencies whose dependent parameter is measured (such as the concluding dependency) are assigned to be bound dependencies, and dependencies whose dependent parameter is unmeasured are assigned to be unbound dependencies.

A collection of quantitative functions representing the dependencies is in effect a predictive model for the system (not necessarily a good predictive model). A function representing a dependency can be referred to as the function of the dependency. The expert provided a portion, if any, of the quantitative functions of the dependencies beforehand. Such dependencies are assigned to be fixed dependencies. The expert provides the functional form of none, some, or all of the functions of the dependencies beforehand. Preferably, the present invention is used when not all of the intermediate parameters 108a . . . 108d are measured (present in the learning database) and not all the dependencies are fixed dependencies, and in particular when at least one of the independent parameters of the concluding dependency is an unmeasured dependent parameter of a dependency which is not a fix dependency.

If all of the independent parameters of the concluding dependency are discrete with finite number of possible values, then a model, which is a collection of functions representing the dependencies, implicitly divides the database into several sub-groups (categories), each having its own unique combination of values of the independent parameters of the concluding dependency. In general, a model that can divide the records into sub-groups may have uses beyond its predictive value. In medical applications, for example, a sub-grouping model can classify patients into those who are most likely to benefit from a specific medical intervention, those who won't benefit, and those patients who are most likely to suffer from adverse side effects.

Preferably, the steps of grouping the relevant parameters and associating a qualitative dependency to each group 20 complies with the following conditions, which ensure that the dependencies fit the general structure of a Knowledge Tree:

a. each of the relevant parameters is a dependent parameter of at most one of the groups;

b. the output parameter of the system is a dependent parameter of one of the groups (the concluding dependencies);

c. any one of the relevant parameters, which is a dependent parameter of one of the groups and is not the output parameter of the system, is an independent parameter of at least one of the groups; and

d. any one of the relevant parameters, which is not measured and is an independent parameter of at least one of the groups, is a dependent parameter of one of the groups; and

e. at least one of the bounded dependencies which are not fixed, has at least one independent parameter which is unmeasured.

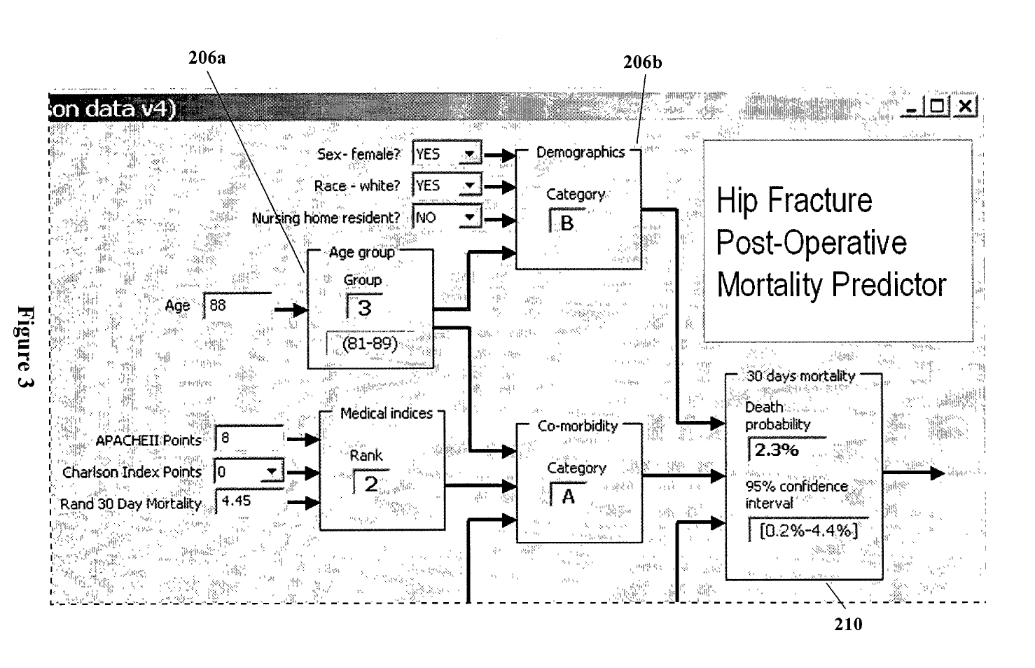

Reference is made to FIG. 3 which presents a portion of a screen shot of a specific embodiment of the present invention. The goal of the embodiment is to predict, before surgery, the mortality in elderly patients with a hip fracture. FIG. 3 present a portion of the Knowledge Tree of the problem, a portion of the data of one specific patient, and the predictions of a specific model constructed by the present invention. In this embodiment the concluding dependency 210 is a bound dependency, a dependency “Age group” 206a is an unbound dependency with a functional form known beforehand, and a dependency “demographics” 206b is an unbound dependency with an unknown functional form.

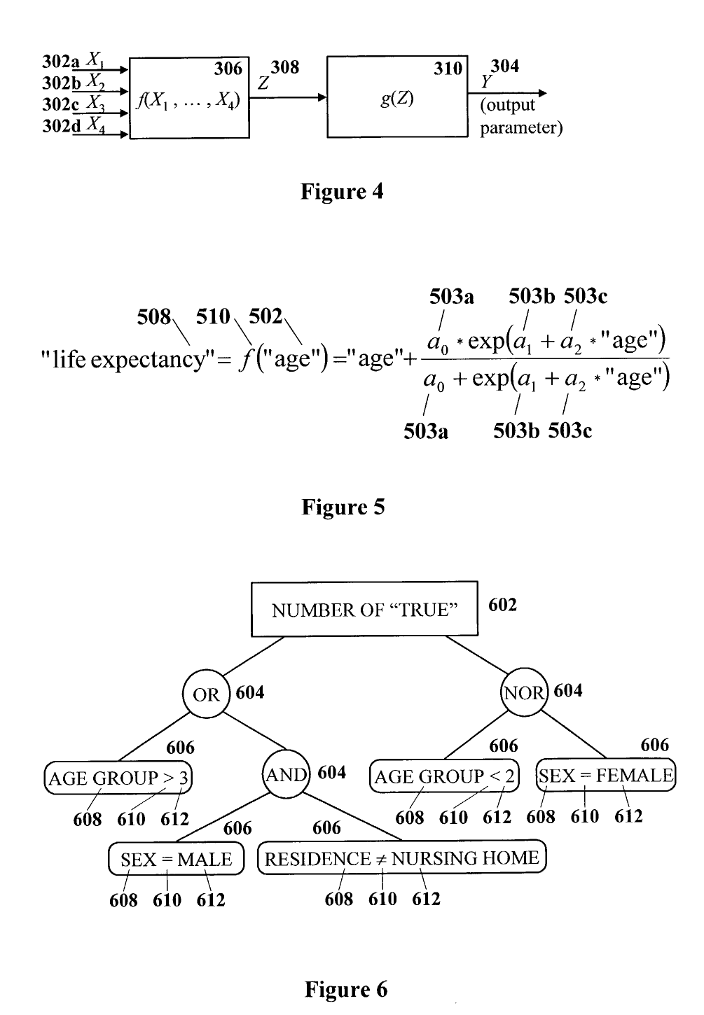

Reference is now made to FIG. 4 which illustrates a special case of a Knowledge Tree, wherein all the relevant input parameters 302a . . . 302d are independent parameters of a single dependency 306, that is, the expert provides no grouping of input parameters. Whereas on one hand the present invention cannot utilize dimension-reduction for improved performance, one the other hand, the present invention is a useful method of data-mining a database wherever there is even a single unmeasured parameter 308. Due to the lack of dimension reduction, common evolutionary algorithms, such as ‘Genetic Algorithms’ or ‘Genetic Programming’, can be adapted for this embodiment, for example by eliminating the concluding dependency 310 and equating z with y. The present invention can be more efficient than the common evolutionary algorithms, as it uses a two-parts models in such embodiment: the intermediate dependency whose function is built without the use of the database and is subject to manipulation during evolutionary algorithm (see below), and the concluding dependency whose function is derived using the database (see below). Thus every model considered during the evolutionary algorithm is at least partially adapted to the database, unlike common evolutionary algorithms.

According to a preferred embodiment, the step of building a plurality of initial predictive models 22 further includes the step of building an initial predictive model at least twice. Building an initial predictive model includes the steps of representing the fixed dependencies by quantitative functions known beforehand, representing the unbound dependencies by randomly built quantitative functions and representing the bound dependencies by quantitative functions derived using the learning database.

The expert provides the functional form of none, some, or all of the functions of the dependencies beforehand. For those of the dependencies whose functional form is provided by the expert and known beforehand, the step of representing the unbound dependencies by randomly built quantitative functions includes selecting random values for free parameters of the functional forms. Referring now to the drawings, FIG. 5 present a functional form of a dependency 510. The dependency has an independent parameter “age” 502 and a dependent parameter “life expectancy” 508. The functional form of the dependency 510 has 3 free parameters a₁, 503a, a₂ 503b, and a₃ 503c. Selecting random values for the free parameters 503a, 503b, 503c sets the function to be a quantitative function.

For those of the dependencies whose functional form is not known, the step of representing the unbound dependencies by randomly built quantitative functions includes building random expressions, which refer to independent parameters of the dependencies and follow recursive syntax.

Without limiting the scope of the present invention and by a way of example only, possible recursive syntax of expressions are given. Such expressions are used as functions of dependencies whose dependent parameter is unmeasured and the functional form of the dependencies' functions are unknown beforehand. The expression is presented graphically as an expression tree (not to be confused with a Knowledge Tree). Each of the sub-expressions of an expression tree is a Boolean expression tree that returns either ‘True’ or ‘False’. Reference is now made to FIG. 6 which illustrates an example where the output of the quantitative function 602 is the number of sub-expressions that return the value ‘True’. There are two sub-expressions, thus the number of sub-expressions returning ‘True’ can be either 0, 1 or 2. Each sub-expression can be either a Boolean operator 604 with two sub-expressions or a basic comparison 606. A Boolean operator 604 is one of ‘And’, ‘Or’, ‘Nand’ (not and), and ‘Nor’ (not or). Each operator combines two sub-expressions in the usual meaning implied from its name. A basic comparison 606 is a comparison of one of the independent parameters 608 of the dependency to a legitimate value 612 of this specific parameter. The comparison operator is one of “equal to”, “greater than”, “less than”, “not equal to”, “not greater than”, and “not less than” 610.

According to a preferred embodiment, the step of representing the bound dependencies by quantitative functions derived using the learning database further includes the step of calculating values of independent parameters of the dependencies for all records in the learning database, wherein some of the independent parameters are measured and the reminder of the independent parameters are dependent parameters of known quantitative functions, either known functions of fixed dependencies or previously built functions of unbound dependencies, and deriving a quantitative function by relating the independent parameters and the dependent parameter using a known statistical method to relate dependent parameter to at least one independent parameters. There are many statistical methods known for deriving such relations, such as multiple linear regression, logistic regression, lookup table pointing to the mean of the dependent parameter, and other methods known to those skilled in the art. For a specific dependency whose function is derived using the learning database, it is preferable that the same method should be used for all of the derivations in the same execution of the algorithm. The method used to derive quantitative function depends on the type of the dependent parameter (e.g. continuous vs. discrete, multiple possible values vs. Boolean variable), on the type of the virtual inputs (e.g. finite number of combinations of values vs. infinite number of combinations), and on the type of problem. One of the purposes of building the Knowledge Tree is to ensure that the number of dependent parameters in these derivations is small and thus such methods for calculating the quantitative function are computationally feasible.

According to a preferred embodiment, the step of building additional predictive models further comprises the step of assigning the initial predictive models to be current set of models and iterating an evolution procedure until a stopping criteria is met.

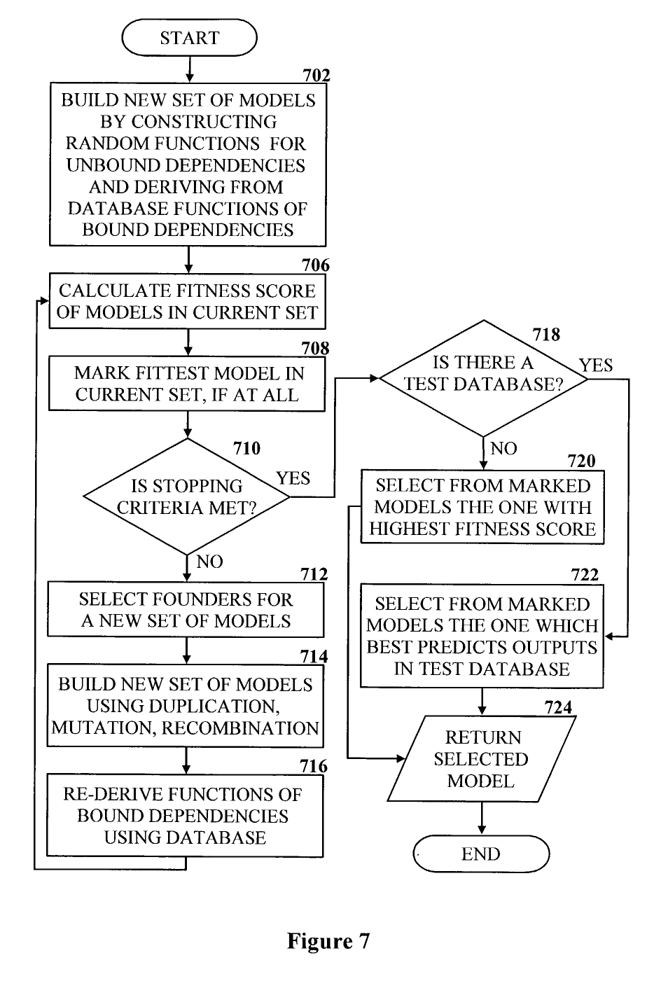

Reference is made to FIG. 7 which shows a flowchart of a portion of a preferred embodiment of the present invention, the iterative evolutionary algorithm 706, 708, 710, 712, 714, 716 and related steps: the step of building a plurality of initial predictive models for the system 702, and the step of selecting the most reliable of the marked models 718, 720, 722.

According to a preferred embodiment, the step of iterating an evolutionary procedure further includes the steps of calculating a fitness score for each model in the current set of models 706, the fitness score is based on the model's predictions of values of the at least one output parameter in the learning database, wherein a higher fitness score indicates better predictive accuracy and reliability, and marking some, if any, of the models in the current set of models 708, wherein preferably a model is marked only if it has a fitness score higher than the fitness score of all previously marked models and preferably a model is marked only if it has the highest fitness score in the current set of models.

According to a preferred embodiment, the step of iterating an evolutionary procedure further includes the additional step of checking the stopping criteria and continuing only if the stopping criteria is not met 710, wherein the stopping criteria is based on the fitness score of the models in the current set of models and on the number of iterations iterated by the evolutionary procedure. According to a preferred embodiment, the step of iterating an evolutionary procedure further includes the additional step of selecting from the current set of models a set of founders for a new set of models 712, wherein the selecting is a probabilistic process based on the fitness score of models in the current set of models, and building from the set of founders a new set of models 714. Each model in the new set is a result of either duplicating a model from the founders set, mutating a model from the founders set, or recombining at least two models from the founders set. According to a preferred embodiment, the step of iterating an evolutionary procedure further includes the additional step of re-deriving the quantitative functions of the dependencies whose dependent parameter is measured (the bound dependencies), the re-deriving is done by using the learning database 716. The new set of models is assigned to be current set of models and the evolutionary procedure is re-iterated.

The calculation of the fitness score relies on standard statistical tools for evaluation of a model, such as R-squared, Mallow's Cₚ, log-likelihood, Akaike's Information Criterion (AIC), area under ROC curve, and other tools familiar to those skilled in the art. The type of dependent parameter and independent parameters of the concluding dependency determines which of these evaluation tools is applicable to the specific embodiment. The combination of tools used and their relative weight in calculating the fitness score depends on the type of the least one output parameter of the system, on the functional form of the function of the concluding dependency and on desired characteristics of predictive model. For example, in some problems, deviation of the prediction to one direction should be weighted differently than deviation of the prediction to a different direction.

If all the independent parameters of the concluding dependency are discrete with finite number of possible values, then the model divides the database into several sub-groups (categories) as described above. The subgrouping can also be weighted into the fitness score, either explicitly using standard statistical tools for checking uniformity of groups and their distinctiveness, or be incorporated into the tools mentioned above for example AIC and adjusted R-squared.

According to a preferred embodiment, the step of mutating a model from the founders set further includes the step of performing minor change in at least one of those of the functions which are functions of unbound and not fixed dependencies, i.e. those dependencies whose function is not known beforehand and their dependent parameter is not measured. Minor change to a function whose functional form is known beforehand, such as 510 in FIG. 5, further comprises the step of setting random values to all or some of the free parameters of the function 503a, 503b, 503c. Minor change to a function whose functional form is not known, such as 602 in FIG. 6, further includes the steps of selecting a sub-expression of the expression, and replacing it by a new, randomly built sub-expression, where the new sub-expression follow the same recursive syntax as the selected sub-expression and refer to independent parameters of the dependency.

According to a preferred embodiment, the step of recombining at least two models from the founders set further comprises the steps of selecting one of the at least two models to be a recipient model and the remaining models to be donor models, recombining at least one of the functions which are functions of unbound and not fixed dependencies in the recipient model with functions of the same dependencies in the donor model. Recombining functions whose functional form is known beforehand further includes the steps of selecting a portion of the free parameters in the functional form, and replacing the values of the selected free parameters in the function of the recipient model with the values of the selected free parameters in the donor models. Recombining functions whose functional form is not known further includes the steps of selecting sub-expressions from the expression of the recipient model and replacing the selected sub-expressions with sub-expressions of functions of the same dependency in the donor models.

According to a preferred embodiment, the step of re-deriving the quantitative functions further includes the step of calculating values of independent parameters of the dependencies for all records in the learning database, wherein some of the independent parameters are measured and the reminder of the independent parameters are dependent parameters of known quantitative functions, either known functions of fixed dependencies or previously built functions of unbound dependencies, and deriving a quantitative function by relating the independent parameters and the dependent parameter using a known statistical method to relate dependent parameter to at least one independent parameters. Preferably, the re-deriving the quantitative functions of the bound dependencies in the new set of models is done with the same method used to derive the quantitative functions of the bound dependencies in the initial predictive models.

According to a preferred embodiment, the step of selecting the most reliable of the marked models 28 is done by either selecting from the marked models the model with the highest fitness score 720, or is based on predictive accuracy on a historical database of the system different from the learning database (‘test database’) 722. The second method of selection (using test database) is considered more reliable (in statistical terms, it reduces the chances of over-fitting the data), and is preferable whenever there exist a test database.

According to another preferred embodiment of the present invention there is provided an apparatus for constructing a model for predicting values of an output parameter of a system from input parameters and attributes of the system, the apparatus include a knowledge engineering tool for defining dependencies between the input parameters, the attributes and the at least one output parameter of the system, wherein at least a portion of the dependencies are not quantitatively known and at least a portion of the attributes are unmeasured. The apparatus further includes a first model generator for building a plurality of initial predictive models for the system, the initial predictive models having quantitative functions representing the dependencies, wherein at least one of the quantitative functions is derived using a learning database. The apparatus further includes a second model generator for building additional predictive models with increasing accuracy in a process of an iterative evolutionary algorithm, the additional predictive models having quantitative functions representing the dependencies, and the second model generator marking some of the additional predictive models. The apparatus further includes a selector for selecting the most reliable of the marked models based on prediction of values of output parameters in a historical database.

The present invention thus far described is capable of constructing a predictive model out of a historical database and a Knowledge Tree. The model constructed by the present invention can be incorporated into a control or diagnosis system without the assessment of an expert, as it is guaranteed apriori that the model complies with the expert's knowledge (the model “fits” the Knowledge Tree).

According to another preferred embodiment of the present invention there is provided an apparatus for predicting values of an output of a system, the apparatus includes a modeler unit for constructing a model for predicting values of the output parameter from input parameters and attributes of the system, the apparatus includes a knowledge engineering tool for defining dependencies between the input parameters, the attributes and the at least one output parameter of the system, wherein at least a portion of the dependencies are not quantitatively known and at least a portion of the attributes are unmeasured. The modeler unit further includes a first model generator for building a plurality of initial predictive models for the system, the initial predictive models having quantitative functions representing the dependencies, wherein at least one of the quantitative functions is derived using a first historical database of the system, a second model generator for building additional predictive models with increasing accuracy in a process of an iterative evolutionary algorithm, the additional predictive models having quantitative functions representing the dependencies, and the second model generator marking some of the additional predictive models. The modeler further includes a selector for selecting the most reliable of the marked models based on prediction of values of output parameters in a historical database, the selected model is assigned to be a working model. The apparatus also includes a diagnosis unit for predicting the at least one output value of the system.

According to a preferred embodiment, the apparatus of diagnosis unit further includes a first data collector for collecting values of at least a portion of the input parameters, a predictor for predicting value of the at least one output parameter of the system, the prediction unit uses for prediction the working model, and an output device for reporting the predicted value of the at least one output of the system.

According to a preferred embodiment, the apparatus of diagnosis unit further includes a first data collector for collecting values of at least a portion of the input parameters a predictor for predicting value of the at least one output parameter of the system, wherein the prediction unit uses for prediction the working model, output device for reporting the predicted value of the at least one output of the system. The diagnosis unit includes also a second data collector for collecting actual output values of the at least one output parameter, a data storage unit for storing the collected data and the collected actual output values and maintaining a updated historical database, a model maintainer for rederiving, based on the updated historical database, the functions of the bound dependencies in the working model.

According to another preferred embodiment of the present invention there is provided an apparatus for controlling values of a output parameter of a system, the apparatus includes a modeler unit for constructing a model for predicting values of the output parameter from input parameters and attributes of the system, the apparatus includes a knowledge engineering tool for defining dependencies between the input parameters, the attributes and the at least one output parameter of the system, wherein at least a portion of the dependencies are not quantitatively known and at least a portion of the attributes are unmeasured. The modeler unit further includes a first model generator for building a plurality of initial predictive models for the system, the initial predictive models having quantitative functions representing the dependencies, wherein at least one of the quantitative functions is derived using a first historical database of the system, a second model generator for building additional predictive models with increasing accuracy in a process of an iterative evolutionary algorithm, the additional predictive models having quantitative functions representing the dependencies, and the second model generator marking some of the additional predictive models. The modeler further includes a selector for selecting the most reliable of the marked models based on prediction of values of output parameters in a historical database, the selected model is assigned to be a working model. The apparatus also includes a control unit for manipulating input parameters of the system and controlling the value of the output parameter of the system.

According to a preferred embodiment, the apparatus of control unit further includes a data collector for collecting values of all or some of the input parameters, wherein some, if any, of the remaining input parameters are assigned to be controllable parameters, a goal input device for indicating to the control unit desired values of the output parameter. In general the goal indicated to the control unit can be more complicated then simple values. It can be any goal function that should be optimized, such as a cost function that should be minimized or a utility function that should be maximized. The apparatus of control unit also includes an optimizer for finding the values of the controllable parameters for which predicted values of the output parameter are similar to the desired values of the output parameter, wherein the optimizer using the working model for predicting values of the at least one output parameter of the system. If a goal function is indicated to the control unit, the optimizer should optimize the goal function. The apparatus of control unit also includes an output device for reporting the found values of the controllable parameters or for setting the parameters to have the found values.

According to another preferred embodiment of the present invention, the apparatus of control unit further includes a first data collector for collecting values of all or some of the input parameters, wherein some, if any, of the remaining input parameters are assigned to be controllable parameters, a goal input device for indicating to the control unit desired values of the output parameter, an optimizer for finding the values of the controllable parameters for which predicted values of the output parameter are similar to the desired values of the output parameter, wherein the optimizer using the working model for predicting values of the at least one output parameter of the system, and an output device for reporting or setting the found values of the controllable parameters. The control unit also includes a second data collector for collecting actual output values of the at least one output parameter, a data storage unit for storing the collected data and the collected actual output values and maintaining a updated historical database, a model maintainer for re-deriving, based on the updated historical database, the functions of the bound dependencies in the working model.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for constructing a model for predicting values of at least one output parameter of a system from input parameters and attributes of the system, the method comprising the steps of:
a) defining dependencies between the input parameters, the attributes and the at least one output parameter of the system, wherein at least a portion of said dependencies are quantitatively unknown and at least a portion of said attributes are unmeasured;
b) building a plurality of initial predictive models for the system, said initial predictive models having quantitative functions representing said dependencies, wherein at least one of said quantitative functions is derived using a first historical database of the system;
c) building additional predictive models with increasing accuracy in a process of an iterative evolutionary algorithm, said additional predictive models having quantitative functions representing said dependencies, and marking some of said additional predictive models; and
d) selecting the most reliable of said marked models based on prediction of values of output parameters in a historical database.

2. The method of claim 1 wherein the step of defining dependencies further comprises the steps of:
assigning the at least one output parameter and at least a portion of said input parameters and attributes of the system to be relevant parameters of the system;
grouping said relevant parameters into groups of at least two, wherein any one of said relevant parameters is a member of at least one of said groups; and
associating a qualitative dependency to each group of said groups wherein a single relevant parameter of said group is assigned to be a dependent parameter, and all of remaining relevant parameters of said group are assigned to be independent parameters.

3. The method of claim 2 wherein said grouping said relevant parameters and said associating a qualitative dependency to each group is complying with the conditions that:
each of said relevant parameters is a dependent parameter of at most one of said groups;
the at least one output parameter of the system is a dependent parameter of one of said groups;
any one of said relevant parameters which is a dependent parameter of one of said groups and is not the output parameter of the system is an independent parameter of at least one of said groups;
any one of said relevant parameters which is not measured and is an independent parameter of at least one of said groups, is a dependent parameter of one of said groups; and
the group whose dependent parameter is the output parameter of the system has at least one independent parameter which is unmeasured.

4. The method of claim 3 wherein said assigning and said grouping and said associating is based on expert knowledge of the system.

5. The method of claim 1, wherein the step of building a plurality of initial predictive models further comprises the steps of:
assigning the at least one output parameter and at least a portion of the input parameters and attributes of the system to be relevant parameters of the system;
to each one of said dependencies, associating one of said relevant parameters to be a dependent parameter, and at least one of remaining relevant parameters to be independent parameters;
representing a portion of said dependencies for which quantitative functions are known beforehand by said quantitative functions;
representing by randomly built quantitative functions a portion of said dependencies whose dependent parameter is unmeasured; and
representing by quantitative functions derived using said first historical database a portion of said dependencies whose dependent parameter is measured.

6. The method of claim 4, wherein the step of representing by randomly built quantitative functions further comprises the steps of:
selecting random values of parameters for a portion of said dependencies whose functional form is known beforehand and substituting said random values for free parameters of said functional form, and;
building random expressions for a portion of said dependencies whose functional form is unknown, where said random expressions follow a recursive syntax and said random expressions refer to independent parameters of said dependencies.

7. The method of claim 4, wherein the step of representing by quantitative functions derived using said first historical database further comprises the steps of:
calculating values of independent parameters of said dependencies for all records in said historical database, wherein a portion, if any, of said independent parameters are measured, and reminder of said independent parameters are dependent parameters of known quantitative functions or randomly built quantitative functions; and
deriving a quantitative function by relating said independent parameters and said dependent parameter using a known statistical method to relate dependent parameter to at least one independent parameters.

8. The method of claim 1 wherein the step of building additional predictive models further comprises the steps of:
assigning the at least one output parameter and at least a portion of the input parameters and attributes of the system to be relevant parameters of the system;
to each one of said dependencies, associating one of said relevant parameters to be a dependent parameter, and at least one of remaining relevant parameters to be independent parameters;
assigning said initial predictive models to be current set of models; and iterating an evolutionary procedure until a stopping criteria is met.

9. The method of claim 8 wherein the step of iterating an evolutionary procedure further comprises the steps of:
calculating a fitness score for each model in said current set of models, said fitness score is based on said model prediction of values in said first historical database of the system of the at least one output parameter of the system, wherein a higher fitness score indicates better predictive accuracy and reliability;
marking at most one of the models in said current set of models, wherein a model is marked if said model has a highest fitness score in said current set of models and said modal has a fitness score higher than the fitness score of all previously marked models;
checking said stopping criteria and continuing only if said stopping criteria is not met, wherein said stopping criteria is based on said fitness score of the models in said current set of models and on the number of iterations iterated by said evolutionary procedure;
selecting from said current set of models a set of founders for a new set of models, wherein said selecting is a probabilistic process based on said fitness score of models in said current set of models;
building from said set of founders a new set of models, wherein each model in said new set is at least one item selected from the group consisting of duplicating a model from said founders set, mutating a model from said founders set, and recombining at least two models from said founders set;
re-deriving said quantitative functions that represent a portion of said dependencies whose dependent parameter is measured, said re-deriving is done by using said first historical database; and
assigning said new set of models to be current set of models.

10. The method of claim 9 wherein the step of mutating a model from said founders set further comprises the step of performing minor change in each function of said functions with unmeasured dependent parameter, wherein said minor change does not change functional form of a portion of said functions whose functional form is known beforehand.

11. The method of claim 9 wherein the step of recombining at least two models from said founders set further comprises the steps of:
selecting a first model from said at least two models to be a recipient model and remaining models from said at least two models to be donor models; and
recombining each function of a portion of said functions of said recipient model, said function's dependent parameter is unmeasured, with functions of said donor models representing dependency same as dependency represented by said function of said recipient model, wherein recombining further comprises the step of replacing a portion of said function of said recipient model with portions of said functions of said donor models.

12. The method of claim 9 wherein the step of re-deriving said quantitative functions that represent a portion of said dependencies whose dependent parameter is measured further comprises the steps of:
calculating values of independent parameters of said dependencies for all records in said historical database, wherein a portion, if any, of said independent parameters are measured, and reminder of said independent parameters are dependent parameters of quantitative functions; and
deriving a quantitative function by relating said independent parameters and said dependent parameter using a known statistical method to relate dependent parameter to at least one independent parameters.

13. The method of claim 1 wherein selecting the most reliable of said marked models is based on predictive accuracy and reliability on said first historical database of the system.

14. The method of claim 1 wherein selecting the most reliable of said marked models is based on predictive accuracy on a second historical database of the system.

15. An apparatus for constructing a model for predicting values of at least one output parameter of a system from input parameters and attributes of the system, the apparatus comprising:
a) a knowledge engineering tool for defining dependencies between the input parameters, the attributes and the at least one output parameter of the system, wherein at least a portion of said dependencies are quantitatively unknown and at least a portion of said attributes are unmeasured;
b) a first model generator for building a plurality of initial predictive models for the system, said initial predictive models having quantitative functions representing said dependencies, wherein at least one of said quantitative functions is derived using a first historical database of the system; and
c) a second model generator for building additional predictive models with increasing accuracy in a process of an iterative evolutionary algorithm, said additional predictive models having quantitative functions representing said dependencies, and said second model generator marking some of said additional predictive models; and
d) a selector for selecting the most reliable of said marked models based on prediction of values of output parameters in a historical database.

16. An apparatus for predicting and controlling values of at least one output of a system, said apparatus comprises:
a) a modeler unit for constructing a model for predicting values of the least one output parameter of a system from input parameters and attributes of the system, the apparatus comprising:
(i) a knowledge engineering tool for defining dependencies between said input parameters, said attributes and the at least one output parameter of the system, wherein at least a portion of said dependencies are quantitatively unknown and at least a portion of said attributes are unmeasured;
(ii) a first model generator for building a plurality of initial predictive models for the system, said initial predictive models having quantitative functions representing said dependencies, wherein at least one of said quantitative functions is derived using a first historical database of the system; and
(iii) a second model generator for building additional predictive models with increasing accuracy in a process of an iterative evolutionary algorithm, said additional predictive models having quantitative functions representing said dependencies, and said second model generator marking some of said additional predictive models; and
(iv) a selector for selecting the most reliable of said marked models based on prediction of values of output parameters in a historical database, said selected model is assigned to be a working model; and
b) a diagnosis unit for predicting the at least one output value of the system.

17. The apparatus of claim 16 wherein the diagnosis unit further comprises:
a first data collector for collecting values of a portion of said input parameters;
a predictor for predicting value of said at least one output parameter of the system, said prediction unit uses said working model for prediction; and
an output device for reporting the predicted value of the at least one output of the system.

18. The apparatus of claim 17 wherein the diagnosis unit further comprises:
a second data collector for collecting actual output values of said at least one output parameter;
a data storage unit for storing said collected data and said collected actual output values and maintaining a updated historical database; and
a model maintainer for re-deriving a portion of said functions of said working model based on said updated historical database.

19. An apparatus for controlling values of at least one output of a system, said apparatus comprises:
a) a modeler unit for constructing a model for predicting values of the least one output parameter of a system from input parameters and attributes of the system, the apparatus comprising:
(i) a knowledge engineering tool for defining dependencies between said input parameters, said attributes and the at least one output parameter of the system, wherein at least a portion of said dependencies are quantitatively unknown and at least a portion of said attributes are unmeasured;
(ii) a first model generator for building a plurality of initial predictive models for the system, said initial predictive models having quantitative functions representing said dependencies, wherein at least one of said quantitative functions is derived using a first historical database of the system; and
(iii) a second model generator for building additional predictive models with increasing accuracy in a process of an iterative evolutionary algorithm, said additional predictive models having quantitative functions representing said dependencies, and said second model generator marking some of said additional predictive models; and
(iv) a selector for selecting the most reliable of said marked models based on prediction of values of output parameters in a historical database, said selected model is assigned to be a working model; and
b) a control unit for manipulating parameters of the system and controlling the at least one output value of the system.

20. The apparatus of claim 19 wherein the control unit further comprises the
a data collector for collecting values of a portion of said input parameters, wherein a portion of remaining said input parameters are assigned to be controllable parameters;
a goal input device for indicating to said control unit desired values of the at least one output parameter;
an optimizer for finding the values of said controllable parameters for which predicted values of said at least one output parameter of the system are similar to said desired values of the at least one output parameter, said optimizer using said working model for predicting values of said at least one output parameter of the system; and
an output device for reporting said found values of said controllable parameters.

21. The apparatus of claim 20 wherein the control unit further comprises:
a second data collector for collecting actual output values of said at least one output parameter;
a data storage unit for storing said collected data and said collected actual output values and maintaining a updated historical database; and
a model maintainer for re-deriving a portion of said functions of said working model based on said updated historical database.
